(19) United States
(12) Patent Application Publication
(10) Pub. No.: US 2005/0200306 A1
(43) Pub. Date: Sep. 15, 2005

(54) Mobile stage lighting system

(75) Inventors: Christopher J. Conway, Palos Verdes Estates, CA (US); Kenneth C. Allen, North Hollywood, CA (US)

Correspondence Address: Jasper W. Dockrey;Brinks Hofer Gilson & Lione, NBC Tower, Suite 3600, P.O. Box 10395, Chicago, IL, 60610, US

(73) Assignees: Chris Conway Incorporated.; Ken Allen Incorporated.

(21) Appl. No.: 10/796,738

(22) Filed: Mar. 9, 2004

(51) Int. Cl. G03B 15/02

(52) U.S. Cl. 315/291; 315/307

(57) ABSTRACT

A mobile stage lighting system configured to be positioned on a film stage and cast soft light upon subjects and objects on stage. The lighting system includes a light frame having a plurality of light sources positioned within the frame. A mobile support is positioned below the frame and enables the frame to be moved. A diffusion film is disposed in front of the plurality of light sources and an eggcrate louver is positioned adjacent the diffusion film. Panels having light-reflective inner surfaces cover the back and sides of the diffusion frame. A light control system regulates electrical power to the plurality of light sources, such that an illumination intensity of individual ones of the plurality of light sources can be varied.

### TECHNICAL FIELD

This invention relates, generally, to lighting systems and fixtures for use in illuminating objects to be filmed or photographed and, more particularly, to high-powered, multi-source lighting systems that cast soft light upon objects to be filmed during motion picture production.

### BACKGROUND

Lighting systems are commonly used in motion picture production, television filming, and other stage events, such as theater productions, advertising production and the like. Most lighting applications of this nature require diffused light to properly illuminate the objects to be filmed. The objects to be illuminated often vary in size and shape and can be distributed across a large floor space. Further, in addition to interior stages and film sets, film lighting sources are frequently employed outdoors. Accordingly, in addition to requiring that the light source have sufficient power to cast light over a wide area, the lighting system also needs to be adaptable to outdoor conditions.

For filming purposes, soft light is desirable to properly illuminate the objects being filmed. Soft light, as opposed to hard light, avoids creating hard, crisp shadows, which can defeat the desired artistic aspects of a scene being filmed, for example, in a motion picture.

For many years, bank lights have been used in the photography industry to illuminate large objects, such as automobiles, and boats and the like, for advertising purposes. While bank lights have been configured to produce intense, diffused light, such systems are often large and cumbersome, and time-consuming to assemble for use. For example, when many employing bank lights of the prior art, lighting technicians must custom assemble the light systems at a desired location. Once assembled, the lighting technician applies diffusion material to the frames to obtain the desired soft light illumination. After applying the proper diffusion materials, the prior art bank lights must be carefully covered to ensure that unwanted light does not escape from the bank light.

For applications in the motion picture industry, bank lights must be frequently assembled, disassembled, and reassembled to accommodate the needs of changing scenes during the filming of the motion picture. The need to constantly assemble and reassemble the lighting equipment during motion picture filming slows down the filming process and can dramatically increase the costs of motion picture production. Further, since the staging and surrounding environment of the various scenes filmed in a motion picture vary widely, the qualities of the soft light must be adjusted to accommodate the needs of the changing scene environment. Also, to properly illuminate a scene for motion picture filming, the intensity, color hue, direction, and the like, must be adjustable. A lighting system that can be easily and efficiently moved, set up, and adjusted will more readily accommodate the needs of the motion picture industry. Although numerous light cabinets mounted on mobile systems exist, none of these lighting systems are configured to specifically address the foregoing requirements for efficient use by the stage and film industry.

### BRIEF SUMMARY

The present invention provides a mobile, high-intensity soft light source that is fully adjustable to accommodate a wide variety of illumination needs. In one embodiment of the invention, a mobile stage lighting system is configured to be positioned on a film stage so as to cast soft light upon the subjects and objects on the stage. The system includes a light frame having a plurality of light sources positioned within the frame. A light reflective backing covers a rear portion and edge portions of the light frame. A diffusion frame is detachably mounted to a front portion of the light frame. A bail is coupled to the light frame and configured to permit the light frame to be moved about the stage. A light control system is configured to supply electrical power to the plurality of light sources, such that the illumination intensity of a portion of the light sources can be varied so as to produce soft light.

In another embodiment of the invention, a stage lighting system includes a frame having a plurality of light sources positioned within the frame. A mobile support is positioned below the frame that enables the frame to be moved. A diffusion panel is disposed in front of the plurality of light sources. A light control system is configured to regulate electrical power to the plurality of light sources. The illumination intensity of individual ones of the plurality of light sources can be varied.

In another embodiment of the invention, a stage lighting system for illumination of a stage with soft light includes a rectangular frame having a series of light bars positioned therein. A plurality of globes are disposed along the light bars. A reflective surface resides on the rectangular frame behind the plurality of globes. A diffusion layer resides on the rectangular frame in front of the plurality of globes. At least one eggcrate louver resides on the diffusion frame. A mobile support is attached to the rectangular frame and enables the rectangular frame to be moved along a surface. A light control system is configured to regulate electrical power to the plurality of globes, such that the illumination intensity of individual ones of plurality of globes can be varied so as to produce soft light.

### BRIEF DESCRIPTION OF THE DRAWING

FIG. 1 is a perspective view of a lighting system arranged in accordance with one embodiment of the invention;

FIG. 2 is a perspective view of the light frame and light sources within the light system illustrated in FIG. 1;

FIG. 3 is a front view of a light source arranged in accordance with one embodiment of the invention and positioned in front of a reflective fabric;

FIG. 4 is a rear view of the lighting system illustrated in FIG. 1;

FIG. 5 is a plain view of a top panel used in the lighting system illustrated in FIG. 1;

FIG. 6 is a plain view of a bottom panel used in the lighting system illustrated in FIG. 1;

FIG. 7a is a partial assembly view the lighting system illustrated in FIG. 1 showing the bracketing system used to attached a diffusion frame and an eggcrate louver to the light frame illustrated in FIG. 2;

FIG. 7b is a perspective view of the diffusion frame shown in FIG. 7a with diffusion films attached to the frame; and

FIG. 8 is a schematic diagram of one embodiment of a lighting control system suitable for use in the lighting system illustrated in FIG. 1.

### DETAILED DESCRIPTION

A perspective view of a lighting system 10 configured in accordance with one embodiment of the invention is illustrated in FIG. 1. Lighting system 10 generally includes a light frame 12 supported by a mobile support or bail 14 positioned below light frame 12. Bail 14 includes upstanding support members 16 that are coupled to pins 18 laterally extending from side portions 20 of light frame 12. Bail 14 further includes casters 22 rotationally mounted on arms 24 radially extending from a support shaft 26.

In accordance with the invention, bail 14 permits light frame 12 to be rolled along a horizontal surface in order to position light frame 12 in a variety of locations on a film stage or other area requiring light illumination. Those skilled in the art will appreciate that although the mobile support is illustrated to have a particular configuration, other types of mobile support systems can also be used to provide mobility for light frame 12. For example, mobile support for light frame 12 can be provided by roller systems, cantilevered support systems, hydraulic systems, telescoping support systems, and the like.

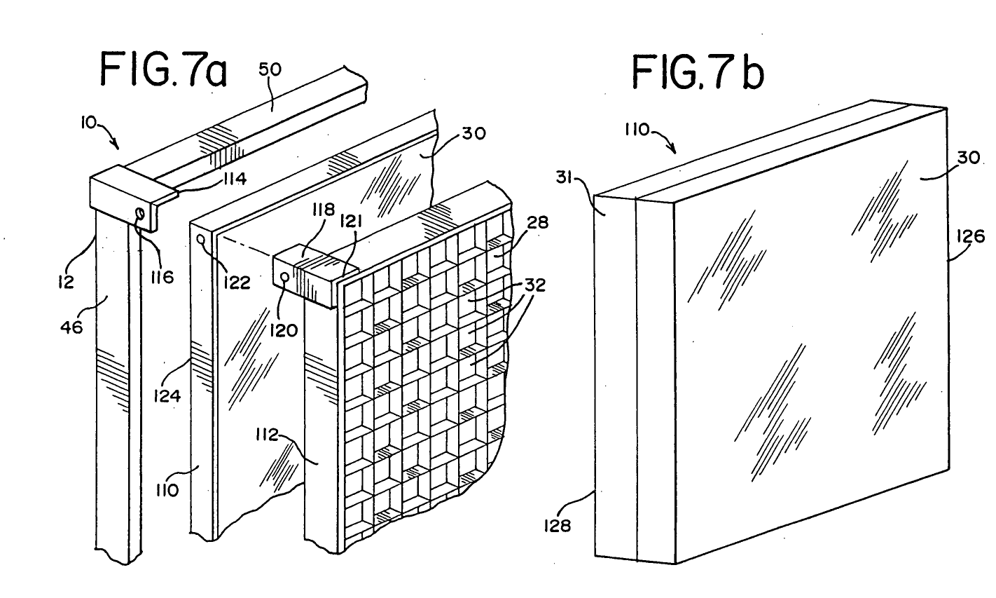

Light frame 12 includes an eggcrate louver 28 positioned over the front of the light frame and a diffusion layer 30 stretched across a diffusion frame that is position in front of light frame 12 and behind eggcrate louver 28 (assembly detail is shown in FIG. 7a). In accordance with the illustrated embodiment, eggcrate louver 28 is a cloth material suspended within a louver frame and arranged in two sections over the front of light frame 12. Eggcrate louver 28 provides a plurality of cells 32 through which light is projected from lighting system 10. In accordance with one embodiment of the invention, each cell has an area dimension of about 3 inches by about 3 inches and a depth of about 3 inches. Those skilled in the art will recognize that the dimensions of cells 32 can vary depending upon the particular light output aspects of the lighting system, and can also vary depending upon the nature of diffusion layer 30.

In accordance with the invention, diffusion layer 30 can be one or more layers of diffusion paper stretched across a diffusion frame and positioned in the front of light frame 12. Those skilled in the art will recognize that numerous types of diffusion materials are available for use by lighting technicians including various types of cloth and paper. Further, the paper varies in thickness and density so that different lighting conditions can be obtained to address the light illumination needs on a particular stage, such as a film stage. As will subsequently be described in more detail, lighting system 10 is configured to permit the easy removal and reinstallation of diffusion layers within the lighting system. Further, the particular light frame configuration of the present invention permits the diffusion frame supporting the diffusion layer to be easily removed and different diffusion materials installed on the frame. The frame can then be easily reattached to light frame 12.

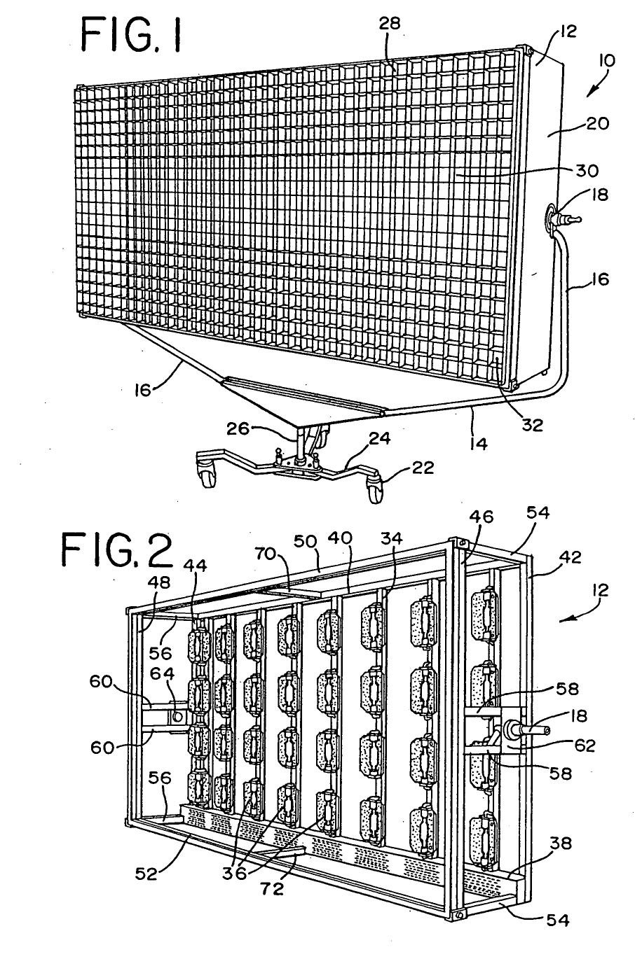

A perspective view of light frame 12 with the panels, diffusion frame, and eggcrate louvers removed is illustrated in FIG. 2. Light frame 12 is generally a rectangular metal frame that includes a plurality of light bars 34 vertically positioned along the long lateral dimension of the rectangular frame. In the illustrated embodiment, light frame 12 has a length dimension that is approximately twice the height dimension, and light bars 34 are evenly spaced along the length dimension. In one embodiment of the invention, light frame 12 is constructed from one inch aluminum channel. The various members of light frame 12 are preferably welded together to provide light frame 12 with sufficient rigidity, yet minimize the total weight of the light frame. Alternatively, the members of light frame 12 can be coupled by other means, such as brackets, bolts, screws, rivets, and the like.

As illustrated in FIG. 2, light frame 12 supports a plurality of globe lights 36. In the illustrated embodiment, each light bar 34 supports four globes evenly spaced along the length of the light bar. Accordingly, a total of thirty two globe lights are arranged in a regular array within light frame 12. Power supplies and electrical wiring for each of globe lights 36 is supplied through a wiring channel 38 laterally extending along the bottom of light frame 12.

Light bars 34 are supported by chase 38 at the bottom and by horizontal member 40 at the top. Horizontal member 40 is connected to vertical members 42 and 44 at the sides of light frame 12. The diffusion frame and the eggcrate louver frame are supported by vertical members 46 and 48 and by horizontal members 50 and 52. Vertical members 46 and 48 are connected to vertical members 42 and 44 by side braces 54 and 56, respectively. Vertical members 42 and 44 are further connected to vertical members 46 and 48 by framing members 58 and 60, respectively. Pins 18 project from the sides of light frame 12 and are welded to plates 62 and 64, which are in turn welded to framing members 58 and 60, respectively. Horizontal members 50 and 52 are also supported by mid-braces 70 and 72, respectively.

As will subsequently be described, the support members and braces of light frame 12 provide a frame structure that can be easily covered with panels of various materials to both reflect and absorb light. Further, the particular arrangement of the frame elements enables light frame 12 to be readily supported by mobile support and rotated about a horizontal axis extending through pins 18. Further, the arrangement of framing elements in light frame 12 permits elements of the electrical system to be positioned within the framing elements, such that electrical wires and components associated with the light control system are not exposed within the light frame.

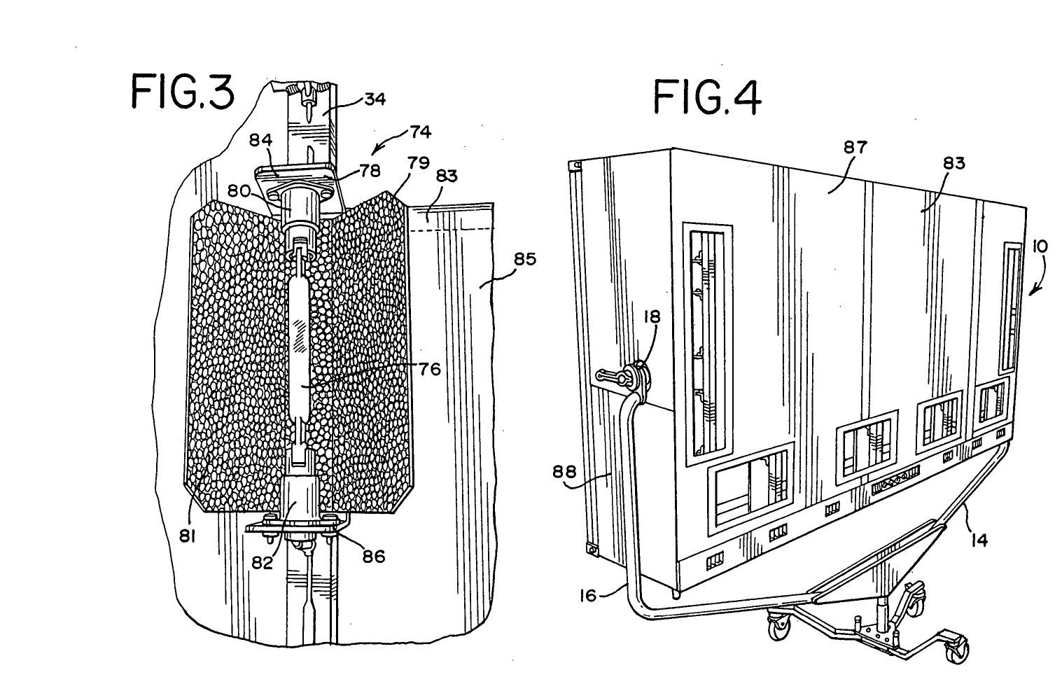

An individual globe light 74 is illustrated in FIG. 3. Globe light 74 includes a tungsten filament housed within a frosted glass cylinder 76. The glass cylinder is mounted within a fixture 78 that includes electrical contacts 80 and 82, which are coupled to mounting brackets 84 and 86, respectively. Fixture 78 is configured to attach the globe light to light bar 34.

In accordance with one embodiment of the invention, the filaments are mounted within frosted glass to provide a high degree of light disbursement of the light emitted by the tungsten filaments. In one embodiment, light frame 12 is configured to house thirty-two 500 watt globe lights that provide a total power output of about 16,000 watts. Alternatively, light frame 12 can accommodate tungsten lights having various wattages. For example, light frame 12 can be configured to house 300-watt globe lights that produce a total power output of about 9,600 watts. The lower power output can be advantageous in lighting situations where less intense soft light is desired.

Globe light 74 also includes a reflector 79 positioned behind frosted cylinder 76. Reflector 79 has a generally parabolic shape that is configured to reflect light rays emitted from frosted cylinder 76 and redirect a portion of the light rays toward the front of light frame 12. To enhance spreading of the reflected light, reflector 79 includes a pitted inner surface 81 adjacent to frosted cylinder 76.

In accordance with a preferred embodiment of the invention, globe light 74 is a model FDN light available from GE Consumer Products, Appliance Park, AP3-232, Louisville, Ky., 40225. Those skilled in the art will appreciate that any of a number of different light sources can be employed in the present invention. For example, other light sources, such as model EHZ lights, and the like can also be used.

As illustrated in FIG. 3, a rear panel 83 is positioned behind globe light 74 and light bar 34. Rear panel 83 is preferably a textile material that includes an inner reflective surface 85 that is designed to reflect light emitted from globe light 74 toward the front of light frame 12.

A rear view of lighting system 10 is illustrated in FIG. 4. The outer surface of rear panel 83 has a black non-reflective surface 87. Side panels 88 are positioned on the ends of light frame 12 and upper and lower panels (not shown) are positioned at the upper and lower sides of light frame 12. In accordance with the illustrated embodiment of the invention, all panels covering the light frame have an inner, light-reflective surface and an outer, non-reflective, black surface. Accordingly, the panels function to suppress light leakage from lighting system 10 while providing a reflective interior surface to ensure that a majority of the light emitted by globe lights 36 from the back and sides is directed out the front of lighting system 10. The black, outer panel surfaces suppress the reflection of ambient light to reduce light interference.

In accordance with one embodiment of the invention, the panels are fabricated from a heat resistant material and the inner reflective surfaces are a silver-impregnated aluminized fabric material. In accordance with the preferred embodiment of the invention, the side panels are fabricated from a commercially available fabric sold under the trade name Heat Resistant Aluminized Fabric, by International Sew-Right Company, 6190 Don Murie Street, Niagra Falls, Ontario L2E 6×8.

A plain view of a top panel 89 is illustrated in FIG. 5. Top panel 89 includes a reflective inner surface 90 and folding ribs 92 that permit top panel 89 to be folded over side braces 54 and 56 of light frame 12. Holes 94 are provided in side portions 96 to permit pins 18 to project therethrough.

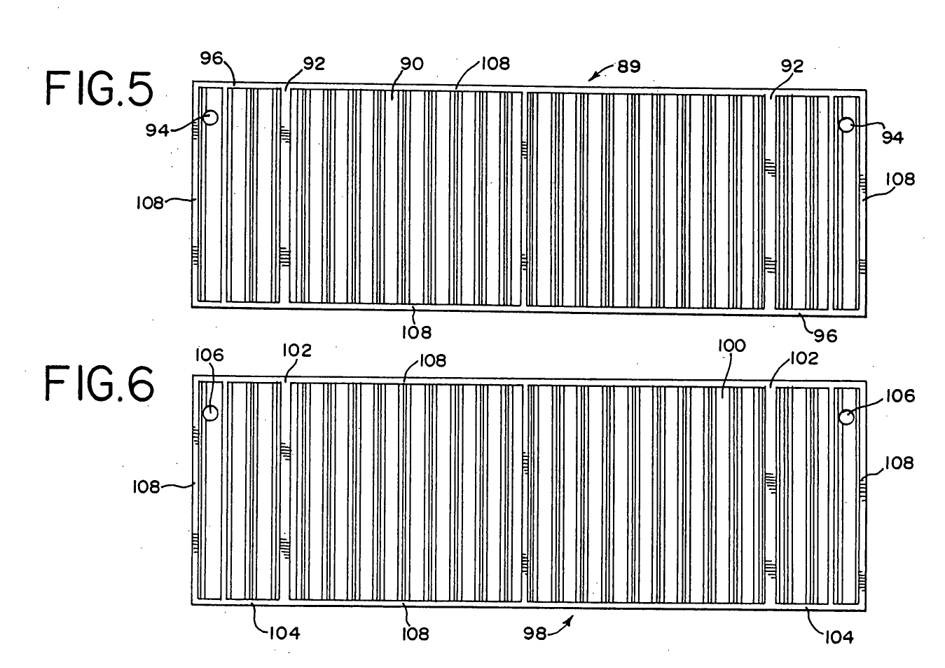

A plain view of a bottom panel 98 is illustrated in FIG. 6. Bottom panel 98 includes a reflective inner surface 100 and fold ribs 102 that permit bottom panel 98 to fold around side braces 54 and 56 of light frame 12. Bottom panel 98 includes side portions 104 and holes 106. When positioned on light frame 12, side portions 104 and side portions 96 are positioned to overlap each other and slide over pins 18. Accordingly, side portions 96 of top panel 89 and side portions 104 of bottom panel 98 cooperate to form side panels 88 shown in FIG. 4. As illustrated in FIGS. 5 and 6, the panels are attached to the light frame and seamed together with Velcro strips 108.

FIG. 7a is a partial assembly view of lighting system 10 showing the bracketing system used to attach a diffusion frame 110 and an eggcrate louver frame 112 to light frame 12. In one embodiment, diffusion frame 110 is a one inch hollow aluminum frame. In accordance with one embodiment, a first corner bracket 114 is attached to an outside corner of light frame 12 where vertical member 46 and horizontal member 50 meet. First corner bracket 114 extends outwardly from light frame 12 and has an opening 116 therein. A second corner bracket 118 is attached to an outside portion of a corner of eqqcrate louver frame 112 and has an opening 120 therein. Second corner bracket 118 is spaced apart from eggcrate louver frame 112 by a shim 121. Diffusion frame 110 includes a threaded hole 122 in a vertical member 124 near the corner of the frame.

When eqqcrate louver frame 112 is brought together with light frame 12, shim 121 permits second corner bracket 118 to slide over the outside edge of first corner bracket 114. Diffusion frame 110 is positioned between eqqcrate louver frame 112 and light frame 12, such that threaded hole 122 aligns with openings 116 and 120 in first and second corner brackets 114 and 118, respectively. A screw or other fastening device is then inserted through openings 116 and 120 and into threaded hole 122. The bracketing system illustrated in FIG. 7a is provided at all of the corners of light frame 12. Accordingly, diffusion frame 110 is secured in position between light frame 12 and eqqcrate louver frame 112.

Those skilled in the art will appreciate that other methods can be used to attach diffusion frame 110 and eqqcrate louver frame 112 to light frame 12 and that the arrangement illustrated in FIG. 7a is one of many different arrangements. For example, clamping devices, temporary adhesive, Velcro attachments, and the like are also possible. Those skilled in the art will further appreciate that the attachment system used to secure diffusion frame 110 can easily be modified to permit more than one diffusion frame to be positioned in front of light frame 12. Accordingly, numerous different layers of a diffusion film can be applied to light frame 12 depending upon the particular illumination requirements.

In accordance with the illustrated embodiment, diffusion frame 110 and eqqcrate louver frame 112 can be easily removed from light frame 12. The bracket arrangement enables the diffusion frame to be removed and various diffusion films applied to the frame. The diffusion frame and eggcrate louver frame can then be quickly reassembled. As described above, this feature permits the diffusion film to be rapidly changed to accommodate different lighting requirements.

A perspective view of diffusion frame 110 is illustrated in FIG. 7b. Diffusion frame 110 is covered by diffusion layer 30 on a first side 126 and by a diffusion layer 31 on a second side 128. Diffusion layers 30 and 31 can be the same material, or alternatively, each diffusion layer can be a different material. Diffusion layers 30 and 31 can be attached to diffusion frame 110 by a variety of attachment mechanisms, including staples, tape, adhesives, Velcro tabs, and the like.

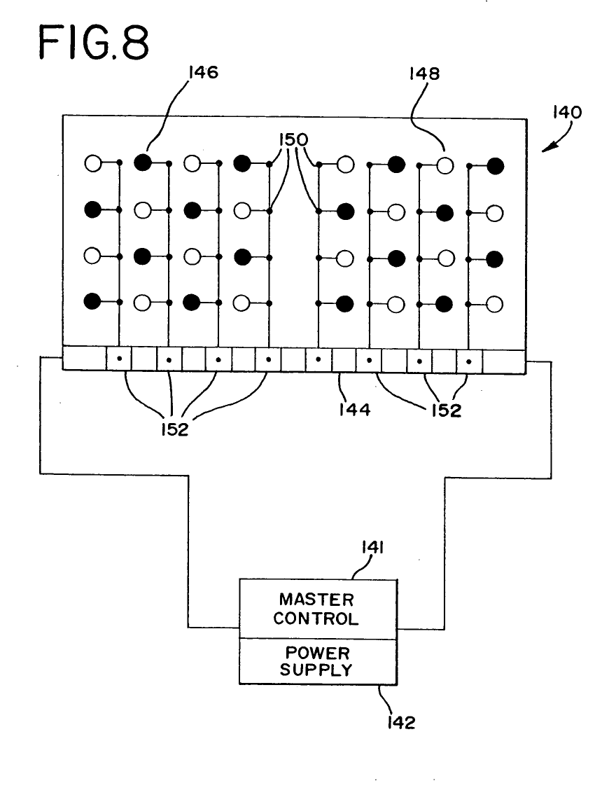

FIG. 8 is a schematic diagram of a lighting control system arranged in accordance with the invention. A light control system 140 includes a master control system 141 and power supply 142 that are electrically coupled to a wiring bus 144. In accordance with one embodiment of the invention, two independent circuits are coupled to master control system 142 through wiring bus 144. Each of the two circuits controls alternating lights. For example, a first circuit controls lights 146 (designated by shading) and a second circuit controls lights 148 (non-shaded). Each light is wired though an individual switch 150. Wiring bus 144 includes a plurality of junctions 152 where each junction provides electrical control to four globe lights arranged on an individual light bar within light frame 12.

Those skilled in the art will appreciate that numerous arrangements are possible for light control system 140. For example, in addition to first and second circuits 146 and 148, additional circuits can be provided to provide an enhanced degree of control over the light output from the lighting system. Further, various additional electrical components, such as diffusers, splitters, and the like can be included in the lighting system to provide additional electrical adjustment capability. In accordance with the preferred embodiment of the invention, power supply 142 is a high-output, commercially-available power supply having 110V, single phase (2 hot legs, neutral, ground) power with 70 amps per leg. The supply power is typically available from either hard wired power supply commonly provided at a stage location, or from a mobile generator.

In accordance with the illustrated embodiment, the circuitry permits the total light output of lighting system 10 to be reduces without a substantial loss in the color temperature. Further, the ability to change the light output of alternating globe lights permits the total light output to be reduced while maintaining uniform illumination intensity. The light output control provided by lighting system 10 is advantages during when lighting system 10 is employed to illuminate scenes during filming. For example, by maintaining color temperature and illumination uniformity, lighting system 10 can be dimmed without requiring a corresponding change in the type of film used in the cameras.

In a preferred embodiment of the invention, lighting system 10 is a rectangular unit in which the light frame has a length dimension of about 8 feet and a height dimension of about 4 feet, and a depth of about 15 inches. By having a long dimension approximately twice the length of the height dimension, lighting system 10 can be employed to wrap light about an illuminated subject or object. Those skilled in the art will recognize, however, that the lighting system of the invention can be constructed of varying dimensions, including a square frame having equal length and height dimensions. For example, light frame 10 can be a square frame having a dimension about 8 feet by about 8 feet.

In accordance with the invention, the total weight of lighting system 10 is limited to a total weight that will allow reasonably easy movement of lighting system 10. In a preferred embodiment, lighting system 10 has a total weight of about 70 lbs. At a total weight of about 70 lbs., lighting system 10 can be easily positioned by one or two lighting technicians. The relative ease of movement enables lighting system 10 to be easily maneuvered to accommodate lighting needs that are rapidly changing during motion picture production.

Further, lighting system 10 is largely self-contained, such that extensive assembly, disassembly, and reassembly are unnecessary when moving the lighting system from one position to another. Those skilled in the art will recognize that the compact design and mobility features of the instant lighting system enable the system to be utilized in a wide variety of lighting applications.

Thus is apparent that there has been described, in accordance with the invention, a mobile stage lighting system that fully provides the advantages set forth above. Those skilled in the art will recognize that numerous modifications and variations can be made without departing from the spirit of the invention. For example, the globe lights can be attached to the light bars by mobile mounting systems that enable individual lights to be independently positioned along the light bars. Accordingly, all such variations and modifications are within the scope of the appended claims and equivalents thereof.

1. A mobile stage lighting system configured to be positioned on a film stage so as to cast soft light upon the subjects and objects on the stage, the system comprising:
a light frame having a plurality of light sources positioned within the frame;
a light reflective backing over a rear portion and side portions of the light frame;
a diffusion frame detachably mounted to a front portion of the light frame;
a mobile support coupled the light frame and configured to permit the light frame to be moved about the stage; and
a light control system configured to regulate electrical power to the plurality of light sources, such that an illumination intensity of a portion of the plurality of light sources can be varied so as to produce soft light.

2. The mobile stage lighting system of claim 1, wherein the plurality of light sources comprise tungsten globe lights having a light reflective shield position between the globe light and the light reflective backing.

3. The mobile stage lighting system of claim 2, wherein the light frame further comprises a plurality of light bars, and wherein the plurality of light sources are evenly distributed along the plurality of light bars.

4. The mobile stage lighting system of claim 1, wherein the light frame comprises a rectangular metal frame having a lateral dimension that is substantially greater than a vertical dimension.

5. The mobile stage lighting system of claim 4, wherein the mobile support comprises a bail that includes upstanding support members adjacent to the side portions of the light frame and coupled thereto by pins laterally extending from the side portions.

6. The mobile stage lighting system of claim 5, wherein the upstanding support members are coupled to the shafts, such that the light frame can be rotated on the bail.

7. A stage lighting system comprising:
a frame having a plurality of light sources positioned within the frame;
a mobile support positioned below the frame that enables the frame to be moved;
a diffusion film disposed in front of the plurality of light sources; and
a light control system configured to regulate electrical power to the plurality of light sources, such that an illumination intensity of individual ones of the plurality of light sources can be varied.

8. The stage lighting system of claim 7, wherein the frame comprises a series of light bars, and wherein the plurality of light sources are disposed along the series of light bars.

9. The stage lighting system of claim 8, wherein the plurality of light sources are evenly spaced along the series of light bars.

10. The stage lighting system of claim 7, wherein the plurality of light sources comprises a plurality of globe lights.

11. The stage lighting system of claim 7, wherein the frame has a first dimension and a second dimension, and wherein the first dimension is about twice the distance of the second dimension.

12. The stage lighting system of claim 11, wherein the frame has a depth substantially less than the second dimension.

13. The stage lighting system of claim 12, wherein the frame comprises a series of light bars arranged parallel to the second frame dimension and wherein the evenly spaced plurality of light sources comprises a plurality of globe lights.

14. The stage lighting system of claim 7 further comprising a light reflective surface positioned on the frame behind the plurality of light sources.

15. The stage lighting system of claim 7 further comprising an eggcrate louver adjacent to the diffusion film.

16. The stage lighting system of claim 7, wherein the light control system comprises two independent circuits, and wherein each of the two independent circuits is coupled to alternating ones of the plurality of light sources.

17. The stage lighting system of claim 16, wherein the light control system comprises independent switches coupled to each of the plurality of light sources.

18. A stage lighting system for illumination of a stage with soft light, the system comprising:
a rectangular frame having a series of light bars positioned therein;
a plurality of globes disposed along the light bars;
a reflective surface on the rectangular frame behind the plurality of globes;
a diffusion layer on the rectangular frame in front of the plurality of globes;
at least one eggcrate louver on the diffusion layer;
a mobile support attached to the rectangular frame that enables the rectangular frame to be moved along a surface; and
a light control system configured to regulate electrical power to the plurality of globes, such that an illumination intensity of individual ones of the plurality of globes can be varied.

19. The stage lighting system of claim 18 further comprising a diffusion frame positioned on the rectangular frame, wherein the diffusion frame is configured to hold at least two diffusion layers.

20. The stage lighting system of claim 18 further comprising:
an eggcrate louver frame supporting the eggcrate louver;
a diffusion frame supporting the diffusion layer;
a first fastening device attached to the rectangular frame and a second fastening device attached to the eggcrate louver frame,
wherein the second fastening device engages the first fastening device to position the diffusion frame between the eggcrate louver frame and the rectangular frame.

21. The stage lighting system of claim 18, wherein the rectangular frame has a length dimension that is approximately twice the height dimension.

22. The stage lighting system of claim 21, wherein the series of light bars comprises eight light bars vertically positioned in the rectangular frame, and wherein the plurality of globes are evenly disposed on the series of light bars.

23. The stage lighting system of claim 22, wherein the plurality of globes comprises thirty two globes in which four globes are evenly spaced along each of the eight light bars.

24. The stage lighting system of claim 18, wherein each of the plurality of globes comprise a tungsten light source and a light reflector positioned in proximity to the light source and configured to reflect light toward the diffusion layer.

25. The stage lighting system of claim 18, wherein the reflective surface comprises a panel having a light-reflective inner surface covering a back side of rectangular frame.

26. The stage lighting system of claim 18, wherein the light control system is arranged such that an illumination intensity of alternating ones of the plurality of globes can be changed.

27. The stage lighting system of claim 18, wherein the light control system is configured such that a color temperature of the illumination from the stage lighting system remains substantially constant when the total light output is reduced.
